(19) United States
(12) Patent Application Publication
(10) Pub. No.: US 2006/0274771 A1
(43) Pub. Date: Dec. 7, 2006

(54) Electronic device

(76) Inventor: Takashi Doi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/409,621

(22) Filed: Apr. 24, 2006

(30) Foreign Application Priority Data
Apr. 27, 2005 (JP) P2005-129578

(51) Int. Cl. H04L 12/56

(52) U.S. Cl. 370/408

(57) ABSTRACT

A transmission source MAC address and a piece of VLAN tag information are extracted from a reception packet, and the piece of VLAN tag information is stored in an MAC address learning table while being associated with the piece of VLAN tag information. A transmission destination MAC address is extracted from a transmission packet. A piece of VLAN tag information associated with the MAC address is acquired from the MAC address learning table. The piece of VLAN tag information is added to the packet and transmitted with the packet.

### CROSS-REFERENCE TO RELATED APPLICATIONS

This application is based upon and claims the benefit of priority from Japanese Patent Application No. 2005-129578, filed on Apr. 27, 2005, the entire contents of which are incorporated herein by reference.

### BACKGROUND

1. Field

One embodiment of the invention relates to a technique of applying VLAN networks to an electronic device for transmitting/receiving data through a computer network configured, for example, in an office, a home, etc.

2. Description of the Related Art

So-called digital household appliances such as DVD recorders, HDD video recorders, etc. have been developed and sold diversely in recent years. With this trend, there are an increasing number of homes with networks configured for connecting these digital household appliances to one another.

How to transmit data efficiently is important for a network through which communication apparatuses are connected to one another. Therefore, a large number of proposals have been made on a technique of finding out and discarding data looped continuously on the network, and on a technique of preventing occurrence of such data (e.g. see JP-A-2004-320248)

For example, in the case of a network configured in an office, there are often used VLAN (Virtual Local Area Network) networks virtually formed. If VLAN networks are designed so that members of a company can use VLAN networks assigned to departments to which the members belong, respectively, in such a manner that the sales department uses a first VLAN network, the general affairs department uses a second VLAN network, etc., a (physically) single network can be used even in a floor environment where members belonging to different departments are mixed. That is, because data can be transmitted/received as if networks configured for departments respectively were used, the job of setting the network can be prevented from being repeated whenever each member moves.

As for a printer, a file server, etc., there is a demand that data should be transmitted/received through a plurality of VLAN networks. To satisfy this demand, there is a relay technique for bridging the plurality of VLAN networks. If the relay technique such as an MAC bridge applied to an access point for wireless LAN connection is used, for example, one printer or one file server can be used in common to the sales department and the general affairs department using different VLAN networks.

If there are electronic devices bridging a plurality of VLAN networks including at least two equivalent VLAN networks, there is a fear that a logical loop path will be formed to thereby generate data looped continuously on the loop path logically formed. The technique disclosed in JP-A-2004-320248 cannot cope with such data looped continuously on the logically formed loop path.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the network configuration of a communication system according to an embodiment of the invention;

FIG. 2 is an exemplary view showing a loop path logically configured by bridging of a plurality of VLAN networks;

FIG. 3 is an exemplary view showing the system configuration of an electronic device according to the embodiment concerned with data communication;

FIG. 4 shows an example of an MAC address learning table contained in the electronic device according to the embodiment;

FIG. 5 shows an example of a VLAN tag information table contained in the electronic device according to the embodiment;

FIG. 6 is an exemplary flow chart showing an operation procedure of an MAC layer in the electronic device according to the embodiment for transmitting a packet received from an LLC layer to a PHY layer; and

FIG. 7 is an exemplary flow chart showing an operation procedure of the MAC layer in the electronic device according to the embodiment for processing a packet received from the PHY layer.

### DETAILED DESCRIPTION

Various embodiments according to the invention will be described hereinafter with reference to the accompanying drawings.

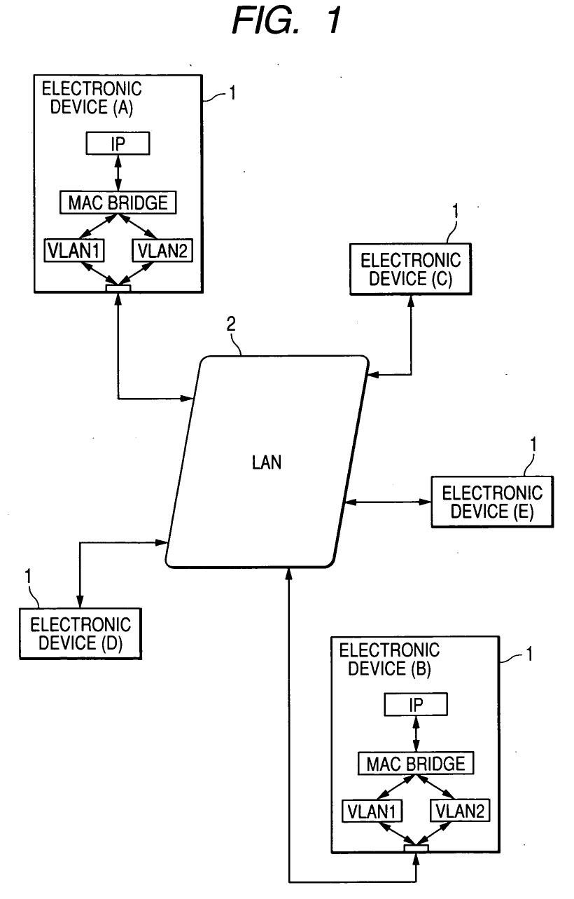

FIG. 1 is a view showing the network configuration of a communication system according to the embodiment of the invention.

The communication system according to the embodiment is configured for transmission/reception of data, for example, among a television set, an HDD video recorder, a personal computer, etc. As shown in FIG. 1, a plurality of electronic devices ((A)-(E)) 1 are connected to an LAN (local area network) 2.

In the communication system, settings for use of VLAN networks are made on a physically single network so that the VLAN networks can operate as if data were transmitted/received through different networks, that is, for example, a first VLAN network between one group of electronic devices 1 and a second VLAN network between another group of electronic devices 1.

Herein, it is assumed that there are at least two VLAN networks, namely, a first VLAN network (VLAN1) and a second VLAN network (VLAN2), as the VLAN networks virtually formed in the aforementioned manner, and that two electronic devices 1 (i.e. the electronic device (A) 1 and the electronic device (B) 1) use the two VLAN networks (i.e. VLAN1 and VLAN2).

That is, each of the electronic device (A) 1 and the electronic device (B) 1 has an MAC bridge for use of the two VLAN networks (i.e. VLAN1 and VLAN2) so that an upper layer such as an IP can gain access to the VLAN networks permeably.

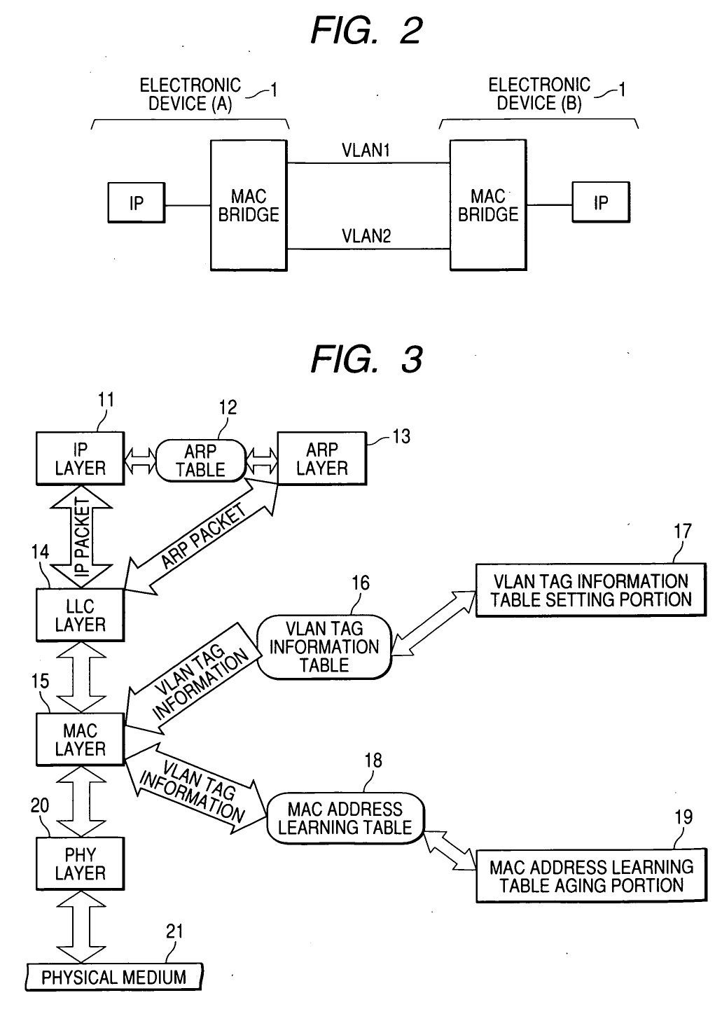

FIG. 2 is a view showing a loop path logically configured by the electronic device (A) 1 and the electronic device (B) 1. When, for example, a broadcast packet for asking an MAC address arrives at the MAC bridge of the electronic device (A) 1, the MAC bridge transfers the packet to the upper layer and also relays the packet to the VLAN2 side.

When the packet relayed to the VLAN2 side arrives at the MAC bridge of the electronic device (B) 1, the MAC bridge of the electronic device (B) 1 transfers the packet to the upper layer and also relays the packet to the VLAN1 side likewise. That is, the packet is looped on the loop path continuously. Therefore, the electronic device according to the embodiment has a mechanism in which data communication using a plurality of VLAN networks can be executed appropriately without occurrence of such looping. This point will be described-below in detail.

FIG. 3 is a view showing the system configuration of the electronic device (A) 1 and the electronic device (B) 1 concerned with data communication.

An IP layer 11 has input/output end points for an upper layer (application layer) and a lower layer (LLC layer 14). An IP protocol is installed in the IP layer 11. The IP layer 11 also has an input/output end point for an ARP table 12. The IP layer 11 acquires the MAC address of a transmission destination by searching an ARP table 12 for the IP address of the transmission destination and sends a transmission packet to the lower layer while adding the acquired MCA address of the transmission destination to the transmission packet.

An ARP layer 13 has an input/output end point for the lower layer (LLC layer 14). An ARP protocol is installed in the ARP layer 13. The ARP layer 13 also has an input/output end point for the ARP table 12 so that the IP address-MAC address relation obtained on the basis of the APR protocol is stored in the ARP table 12.

The LLC layer 14 has input/output end points for the upper layers (the IP layer 11 and the ARP layer 13) and an MAC layer 15. An LLC protocol is installed in the LLC layer 14.

The MAC layer 15 has input/output end points for the LLC layer 14 and a PHY (physical) layer 20. An MAC protocol is installed in the MAC layer 15. The MAC layer 15 also has input/output end points for a VLAN tag information table 16 and an MAC address learning table. When the MAC layer 15 receives a packet from the lower layer, the MAC layer 15 extracts a transmission source MAC address and a piece of VLAN tag information (presence/absence of a tag and a VLAN-ID) from the packet, and then compares the extracted piece of VLAN tag information with all entries in the VLAN tag information table 16. The MAC layer 15 discards packets mismatched with the entries and stores the piece of VLAN tag information of the received packet matched with an entry in the MAC address learning table 18, together with the transmission source MAC address and the reception time.

Upon reception of a transmission packet from the upper layer, the MAC layer 15 searches the MAC address learning table 18 on the basis of the MAC address contained in the packet, adds a piece of VLAN tag information matched with the MAC address to the transmission packet and transfers the transmission packet to the lower layer. When there are a plurality of entries matched with the MAC address in the MAC address learning table 18, the MAC layer 15 selects a piece of VLAN tag information on the basis of priority information set in the VLAN tag information table, adds the selected piece of VLAN tag information to the packet and transfers the packet to the lower layer. When there is no transmission destination MAC address found (i.e. in the case of an unlearned MAC address or broadcasting), the MAC layer 15 refers to the VLAN tag information table 16, generates copies of the packet by the number of VLAN tag information entries, adds pieces of VLAN tag information to the copies of the packet respectively and transfers the copies of the packet to the lower layer.

The PHY layer 20 has input/output end points for a physical medium 21 and the MAC layer 15. The PHY layer 20 implements physical data exchange with the network.

A VLAN tag information table setting portion 17 has an input/output interface with a user, and an input/output end point for the VLAN tag information table 16. The VLAN tag information table setting portion 17 has a function of presenting the entries of the VLAN tag information table 16 to the user, and a function of setting the entries of the VLAN tag information table 16 to values inputted from the user.

An MAC address learning table aging portion 19 has a function of comparing the elapsed time from a reception time point contained in each of the entries of the MAC address learning table 18 to the current time point with the value of aging time, and deleting entries with the elapsed time exceeding the aging time. The MAC address learning table aging portion 19 also has a user input/output function by which the user can set the aging time.

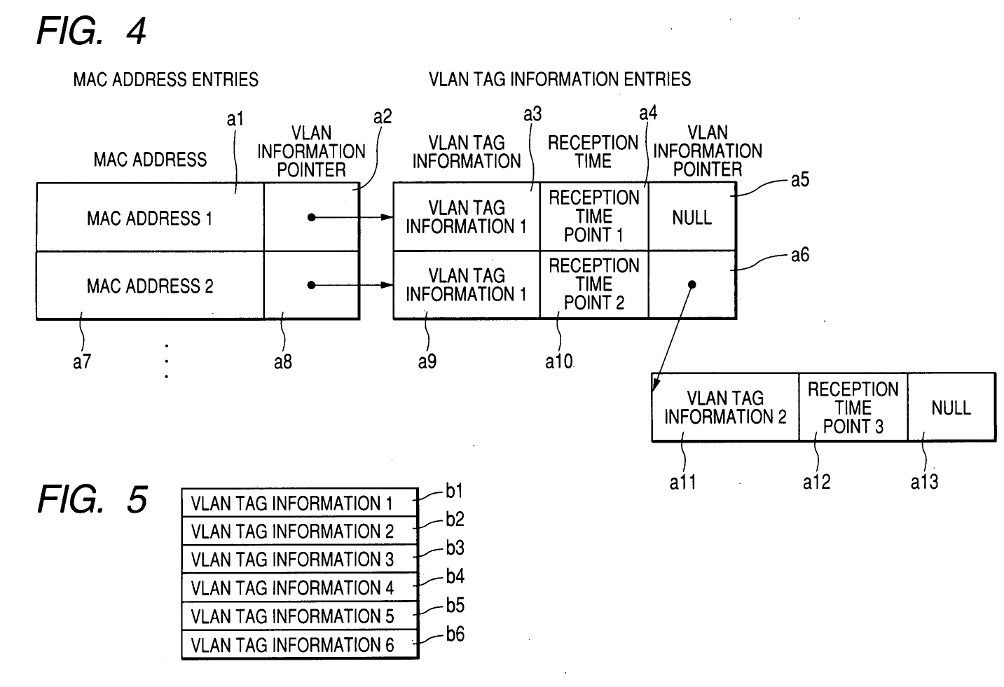

FIG. 4 shows a specific example of the MAC address learning table 18. Transmission source MAC addresses, pieces of VLAN tag information and reception time points extracted from received packets are stored in the MAC address learning table 18. The table contains an arrangement of MAC address entries, and VLAN tag information entries linked from the MAC address entries. Each of the MAC address entries has an MAC address (a1, a7), and a VLAN tag information pointer (a2, a8). The VLAN information pointer points to a corresponding VLAN tag information entry.

Each of the VLAN tag information entries has a piece of VLAN tag information (a3, a9, a11), a reception time point (a4, a10, a12), and a VLAN tag information pointer (a5, a6, a13). The piece of VLAN tag information is data with a length of 16 bits inclusive of less significant 12 bits for indicating a VLAN-ID. When the piece of VLAN tag information has a value “0xFFFF”, it indicates that there is no tag. The VLAN tag information pointer of NULL points to a terminal for indicating that there is no VLAN tag information entry after the terminal.

On the other hand, FIG. 5 shows a specific example of the VLAN tag information table 16. In this example, the VLAN tag information table 16 is implemented by an arrangement of pieces of VLAN tag information (b1 to b6). The VLAN tag information table 16 indicates priority of use given to the pieces of VLAN tag information in order of the arrangement thereof.

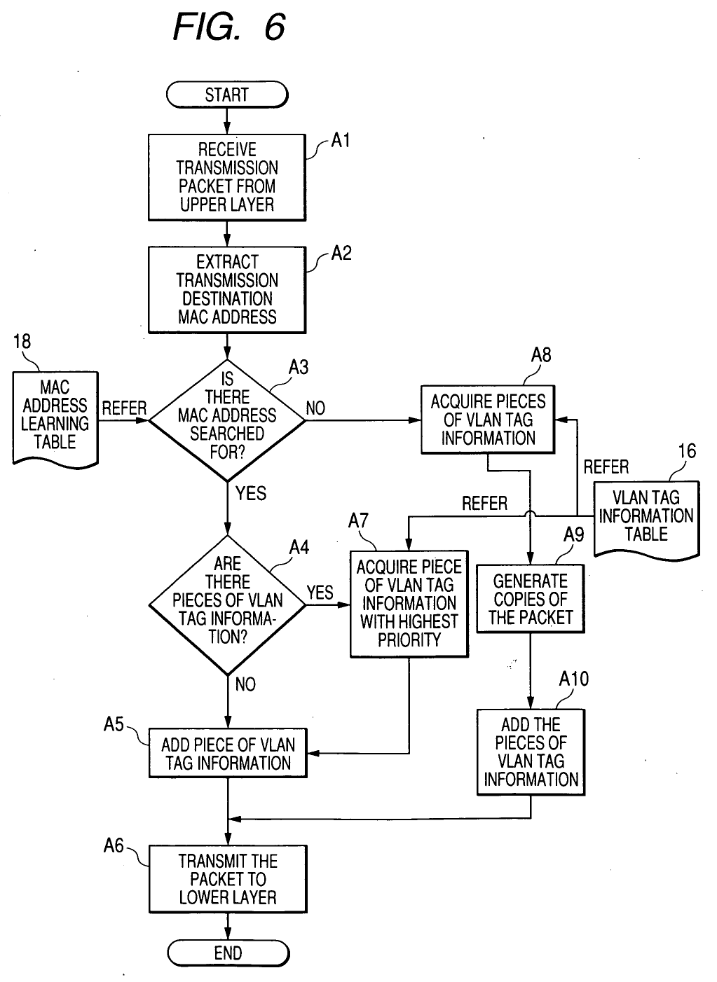

The procedure of an operation of the MAC layer 15 in the electronic device according to the embodiment for transmitting a packet received from the LLC layer 14 to the PHY layer 20 will be described with reference to FIG. 6.

Upon reception of a transmission packet from the upper layer (Step A1), the MAC layer 15 first extracts the MAC address of a transmission destination from the transmission packet (Step A2). The MAC layer 15 compares the extracted transmission destination MAC address with learned MAC address entries of the MAC address learning table 18 (Step A3).

When the MAC address of the transmission destination has been already learned and present in the MAC address learning table 18 (YES in Step A3), the MAC layer 15 judges whether there are a plurality of VLAN tag information entries for the matched MAC address (Step A4). When there is only one VLAN tag information entry (NO in Step A4), the MAC layer 15 adds a VLAN tag to the transmission packet on the basis of the piece of VLAN tag information (Step A5). The transmission packet with the VLAN tag is transferred to the lower layer and transmitted to the network (Step A6).

On the other hand, when there are a plurality of VLAN tag information entries for the matched MAC address (YES in Step A4), the MAC layer 15 searches the VLAN tag information table 16 and selects a piece of VLAN tag information with highest priority from the VLAN tag information table 16 (Step A7). The MAC layer 15 adds a VLAN tag to the transmission packet on the basis of the selected piece of VLAN tag information, transfers the transmission packet to the lower layer and transmits the transmission packet to the network (Steps A5 and A6).

When the transmission destination MAC address extracted from the transmission packet is not present in the MAC address learning table 18 (NO in Step A3), that is, when the MAC address has been not learned yet or is a broadcast address, the MAC layer 15 acquires all VLAN tag information entries registered in the VLAN tag information table 16 (Step A8). The MAC layer 15 generates copies of the packet by the number of the acquired VLAN tag information entries (Step A9), adds VLAN tags to the copies of the packet on the basis of the pieces of VLAN tag information respectively and transfers the copies of the packet to the lower layer (Steps A10 and A6). That is, if N pieces of VLAN tag information have been already registered in the VLAN tag information table 16, the transmission packet is transmitted N times.

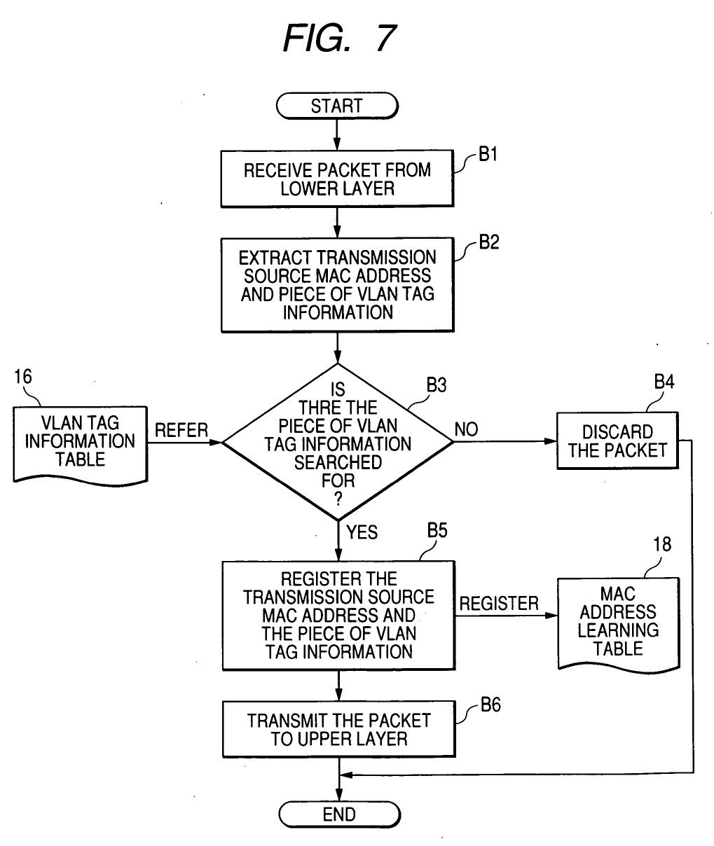

Next, the procedure of an operation of the MAC layer 15 in the electronic device according to the embodiment for processing a packet received from the PHY layer 20 will be described with reference to FIG. 7.

Upon reception of a reception packet from the lower layer (Step B1), the MAC layer 15 first extracts the MAC address of a transmission source and a piece of VLAN tag information from the reception packet (Step B2). The MAC layer 15 searches the VLAN tag information table 16 for the extracted piece of VLAN tag information (Step B3).

When the piece of VLAN tag information is not found (NO in Step B3), the MAC layer 15 discards the reception packet (Step B4). On the other hand, when the piece of VLAN tag information is found in the VLAN tag information table 16 (YES in Step B3), the MAC layer 15 stores the extracted transmission source MAC address, the piece of VLAN tag information and a reception time point in the MAC address learning table 18 (Step B5). After the storage, the MAC layer 15 transfers the reception packet to the upper layer (Step B6).

Because the MAC address and the piece of VLAN tag information are learned while associated with each other in the aforementioned manner so that a VLAN tag to be added to a packet can be adjusted appropriately in accordance with a communication destination, the electronic device according to this embodiment is formed so that the IP layer can make access to different VLAN networks permeably.

In addition, because the problem of a broadcast storm in a loop state in the case of use of an MAC bridge does not occur so that an operation in a promiscuous mode is not required, lowering of system performance can be avoided.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

While certain embodiment of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device that transmits and receives packets through one or more VLAN networks that are virtually configured, the electronic device comprising:
a VLAN tag information table that stores pieces of VLAN tag information for each of the VLAN networks available for transmitting and receiving the packets;
an MAC address table that stores MAC addresses of devices directed to the transmission and reception of the packets, and stores pieces of VLAN tag information for the VLAN networks to be used for the transmission and reception of the packets while associating the pieces of VLAN tag information with the MAC addresses of the devices;
a reception packet processing unit that:
extracts a transmission source MAC address and a piece of VLAN tag information from a received packet;
searches the VLAN tag information table to determine whether or not the extracted piece of VLAN tag information has been already stored in the VLAN tag information table;
when determined that the extracted piece of VLAN tag information has been already stored in the VLAN tag information table, determines that the packet is addressed to the electronic device, and fetches the packet and stores the extracted piece of VLAN tag information in the MAC address table while associating the extracted piece of VLAN tag information with the extracted MAC address; and
when determined that the extracted piece of VLAN tag information is not stored in the VLAN tag information table, determines that the packet is not addressed to the electronic device, and discards the packet; and a transmission packet processing unit that:
extracts a transmission destination MAC address from a packet to be transmitted;
searches the MAC address table to determine whether or not the extracted MAC address has been already stored in the MAC address table;
when determined that the extracted MAC address has been already stored in the MAC address table, adds a piece of VLAN tag information associated with the MAC address in the MAC address table to the packet, and transmits the packet; and
when determined that the extracted MAC address is not stored in the MAC address table, generates copies of the packet by the number of pieces of VLAN tag information stored in the VLAN tag information table, adds pieces of VLAN tag information different from one another to the copies of the packet respectively, and transmits the copies of the packet.

2. The electronic device according to claim 1, wherein the pieces of VLAN tag information contain VLAN tag IDs for VLAN networks respectively.

3. The electronic device according to claim 2, wherein a VLAN network without any VLAN tag is indicated when the VLAN tag ID contained in a piece of VLAN tag information has a predetermined value, and
wherein the transmission packet processing unit does not add any piece of VLAN tag information when the VLAN tag ID contained in the piece of VLAN tag information stored in the VLAN tag information table has the predetermined value.

4. The electronic device according to claim 1, wherein priority of each of the VLAN networks is stored together with a corresponding piece of VLAN tag information in the VLAN tag information table, and
wherein the transmission packet processing unit selects a piece of VLAN tag information for a VLAN network with highest priority from the VLAN tag information table and adds the selected piece of VLAN tag information to the packet when there are a plurality of pieces of VLAN tag information associated with the MAC address.

5. The electronic device according to claim 1, wherein the reception packet processing unit stores a reception time point of each packet in the MAC address table while associating the reception time point with a corresponding piece of VLAN tag information, and
wherein the electronic device further comprises an MAC address table management unit that deletes a piece of VLAN tag information from the MAC address table when an elapsed time from a reception time point of the piece of VLAN tag information exceeds a predetermined time.

6. The electronic device according to claim 5, further comprising a storage time setting unit that sets the predetermined time that is a time allowing each piece of VLAN tag information to be stored in the MAC address table.

7. The electronic device according to claim 1, wherein the transmission packet processing unit does not generate copies of the packet, adds a corresponding piece of VLAN tag information to the packet and transmits the packet when there is one piece of VLAN tag information stored in the VLAN tag information table.

8. The electronic device according to claim 1, further comprising a VLAN tag information table setting unit that sets pieces of VLAN tag information to be stored in the VLAN tag information table.

9. The electronic device according to claim 1, wherein the transmission packet processing unit generates copies of the packet by the number of pieces of VLAN tag information stored in the VLAN tag information table, adds different pieces of VLAN tag information to the copies of the packet respectively and transmits the copies of the packet when the transmission destination MAC address is a broadcast address.

10. The electronic device according to claim 9, wherein the transmission packet processing unit does not generate copies of the packet, adds a corresponding piece of VLAN tag information to the packet and transmits the packet when there is one piece of VLAN tag information stored in the VLAN tag information table.

11. An electronic device that transmits and receives packets through one or more VLAN networks that are virtually configured, the electronic device comprising:
a managing unit that extracts a transmission source MAC address and a piece of VLAN tag information from a reception packet, and manages the extracted piece of VLAN tag information while associating the extracted piece of VLAN tag information with the extracted MAC address; and
a adding unit that extracts a transmission destination MAC address from a transmission packet and adding a piece of VLAN tag information managed while associated with the extracted MAC address to the transmission packet.
